(19) United States
(12) Patent Application Publication
(10) Pub. No.: US 2011/0025644 A1
(43) Pub. Date: Feb. 3, 2011

(54) Touch Control Apparatus, Associated Sensing Control Apparatus and Method Thereof

(75) Inventors: Tsung-Fu Lin, Hsinchu Hsien (TW); Guo-Kiang Hung, Hsinchu Hsien (TW); Yi Cheng Hsieh, Hsinchu Hsien (TW)

Correspondence Address: LEE & HAYES, PLLC, 601 W. RIVERSIDE AVENUE, SUITE 1400, SPOKANE, WA, 99201, US

(73) Assignee: MSTAR SEMICONDUCTOR, INC., Hsinchu Hsien (TW)

(21) Appl. No.: 12/845,580

(22) Filed: Jul. 28, 2010

(30) Foreign Application Priority Data
Jul. 31, 2009 (TW) 098125777

(51) Int. Cl. G06F 3/044; G06F 3/041

(52) U.S. Cl. 345/174; 345/173

(57) ABSTRACT

A touch control apparatus includes a touch panel and a sensing control apparatus. The touch panel includes a plurality of sensing lines, and the sensing control apparatus includes a plurality of pins that are respectively coupled to the sensing lines. The sensing control apparatus adaptively controls a sequence for scanning the pins according to connection relationships between the pins and the sensing lines.

### CROSS REFERENCE TO RELATED PATENT APPLICATIONS

This patent application claims priority from Taiwan Patent Application No. 098125777, filed in the Taiwan Patent Office on Jul. 31, 2009, entitled “Touch Control Apparatus, Associated Sensing Control Apparatus and Method Thereof”, and incorporates the Taiwan patent application in its entirety by reference.

### TECHNICAL FIELD

The present disclosure relates to touch sensing, and more particularly, to a touch control apparatus and associated sensing control apparatus and method capable of controlling a sequence for scanning pins.

### BACKGROUND OF THE PRESENT DISCLOSURE

FIG. 1A shows a schematic diagram of a structure of a conventional capacitive touch panel apparatus 100 comprising a capacitive touch panel 110, a printed circuit board (PCB) 120, and a sensing controller 130.

The capacitive touch panel 110 comprises a plurality of sensing lines comprising nₓ+m_{y} conductive wires, mₓ×nₓ capacitors 111 for sensing an X axis direction of the touch panel 110, and m_{y}×n_{y} capacitors 112 for sensing a Y axis direction of the touch panel 110.

The capacitors 111 are arranged in mₓ columns in the X axis direction and nₓ rows in the Y axis direction, and each row of the capacitors 111 is serially connected to mₓ capacitors 111 via a conductive wire Xn. Ten conductive wires X0 to X9 are illustrated in FIG. 1A, each of which is serially connected to thirteen capacitors 111. The capacitors 112 are arranged to m_{y} columns in the X axis direction and n_{y} rows in the Y axis direction. Each column of the capacitors 112 is serially connected to n_{y} capacitors 112 via a conductive wire Ym. Twelve conductive wires Y0 to Y9 are illustrated in FIG. 1A, each of which is serially connected to nine capacitors 112.

The sensing controller 130 is provided on the PCB 120 comprises a plurality of pins Si, which are respectively coupled to the conductive wires Xn and Ym. In FIG. 1A, there are 22 pins including pins S0 to S11 that are respectively coupled to the conductive wires Y0 to Y11, and pins S12 to S21 that are respectively coupled to the conductive wires X0 to X9. The conventional sensing controller 130 scans in sequence the pins S0 to S21 via a time division approach to receive in sequence capacitance values transmitted from the conductive wires Y0 to Y11 and X0 to X9 via the pins S0 to S21. Each of the capacitance values transmitted from one conductive wire corresponds to capacitance values of all capacitors coupled to the conductive wire. The sensing controller 130 compares the capacitances values to obtain a coordinate signal comprising a coordinate position of a touch on the capacitive touch panel 110.

For example, when a user touches a certain position of the capacitive touch panel 110, an equivalent capacitance value corresponding to the touch is generated by capacitors 111 and 112 at the position or a neighboring position, and is transmitted to the sensing controller 130 via corresponding conductive wires Xn and Ym. The sensing controller 130 respectively receives in sequence the capacitance values from the conductive wires Y0 to Y11 and X0 to X9 via the time division approach. Upon detecting that the capacitance values from the conductive wires Xn and Ym comprised the equivalent capacitance value corresponding to the touch, the sensing controller 130 can calculate a coordinate of the touched position by utilized an X coordinate of the capacitor 111 and a Y coordinate of the capacitor 112 at the position or at the neighboring position.

Since the sensing controller 130 receives in sequence signals transmitted from the pins S0 to S21 via the time division approach, the conductive wires Y0 to Y11 and X0 to X9 need to be connected according to a predetermined sequence, and are correspondingly coupled to the pins S0 to S21 on a one-on-one basis. Therefore, when a circuit layout of the capacitive touch panel 110 is changed, a conductive wire layout on the PCB 120 and at least some of the conductive wires Y0 to Y11 and X0 to X9 outside a sensing area A1 need to be correspondingly changed, so that the conductive wires Y0 to Y11 and X0 to X9 can maintain the corresponding one-on-one relationship with the pins S0 to S21. FIG. 1B and FIG. 1C are schematic diagrams of conductive wire layouts of other conventional capacitive touch panels. Following description is given with reference to FIG. 1A, FIG. 1B and FIG. 1C. Sensing lines of capacitive touch panels 110a and 110b are arranged differently from those of the capacitive touch panel 110. Since the pins S0 to S21 of the conventional controller 130 need to be coupled in a predetermined sequence to the conductive wires Y0 to Y11 and X0 to X9 of the sensing lines of the capacitive touch panel 110, the conductive layout on the PCB 120 and the part of the conductive wires Y0 to Y11 and X0 to X9 outside the sensing area A1 needs to be correspondingly changed to properly connect to corresponding pins of the sensing controller 130. However, the lack of connection flexibilities between capacitors of the capacitive touch panels 110a and 110b and the pins of the sensing controller 130 may cause complication and difficulties in making changes in the conductive wire layout.

### SUMMARY OF THE PRESENT DISCLOSURE

The present disclosure provides a sensing control apparatus capable of simplifying a conductive wire layout between a touch panel and the sensing control apparatus, and a touch control apparatus using the sensing control apparatus.

The present disclosure further provides a method for controlling a touch panel capable of simplifying a conductive wire layout between the touch panel and a sensing control apparatus.

The present disclosure further provide a sensing control apparatus capable of controlling a sequence for scanning pins, and a touch control apparatus using the sensing control apparatus.

According to an embodiment of the present disclosure, a touch control apparatus comprises a touch panel and a sensing control apparatus. The touch panel comprises a plurality of sensing lines, and the sensing control apparatus comprises a plurality of pins that are respectively coupled to the plurality of sensing lines. The sensing control apparatus adaptively controls a sequence for scanning the pins according to connection relationships between the pins and the sensing lines.

According to the present disclosure, the sensing control apparatus comprises an interface circuit and a controller. The interface circuit comprises the plurality of pins, and the controller adaptively controls a sequence for scanning the pins by the interface circuit. In an embodiment, the sensing control apparatus further comprises a coordinate generating apparatus, which respectively receives a plurality of sensing results generated by the sensing lines via the pins of the interface circuit and generates a coordinate data according to the plurality of sensing results.

According to the present disclosure, the interface circuit comprises a plurality of switch components, which are respectively coupled between the pins and the coordinate generating apparatus, and are for selectively and respectively switching between a first status and a second status according to control of the controller. In an embodiment, in a first predetermined mode, the controller controls the interface circuit to simultaneously scan at least some of the pins. In another embodiment, in a second predetermined mode, the controller controls the interface circuit to only scan in sequence at least some of the pins.

According to another embodiment of the present disclosure, a method for controlling a touch panel is applied to a sensing control apparatus comprising a plurality of pins, which are respectively coupled to a plurality of sensing lines of the touch panel. The method comprises determining a sequence for scanning the pins according to connection relationships between the pins and the sensing lines; scanning the pins according to the sequence to respectively receive a plurality of sensing results from the sensing lines; and generating a coordinate data according to the sensing results.

In an embodiment, in a normal mode, the sequence is a first sequence; and in a first predetermined mode, the sequence is a second sequence for controlling to scan at least some of the pins. In another embodiment, in a second predetermined mode, the sequence is a third sequence for simultaneously controlling to scan at least one of the pins.

According to a touch panel apparatus, an associated sensing control apparatus, and a method for controlling a touch panel provided by the present disclosure, the sensing control apparatus is capable of controlling a sequence for scanning pins according to connection relationships between the pins and the sensing lines. Therefore, the pins need not be coupled to the sensing lines in a predetermined sequence, but can be randomly coupled to the sensing lines, so as to simplify a conductive wire layout between the touch panel and the sensing control apparatus.

### BRIEF DESCRIPTION OF THE DRAWINGS

FIG. 1A is a schematic diagram of a structure of a conventional capacitive touch panel apparatus.

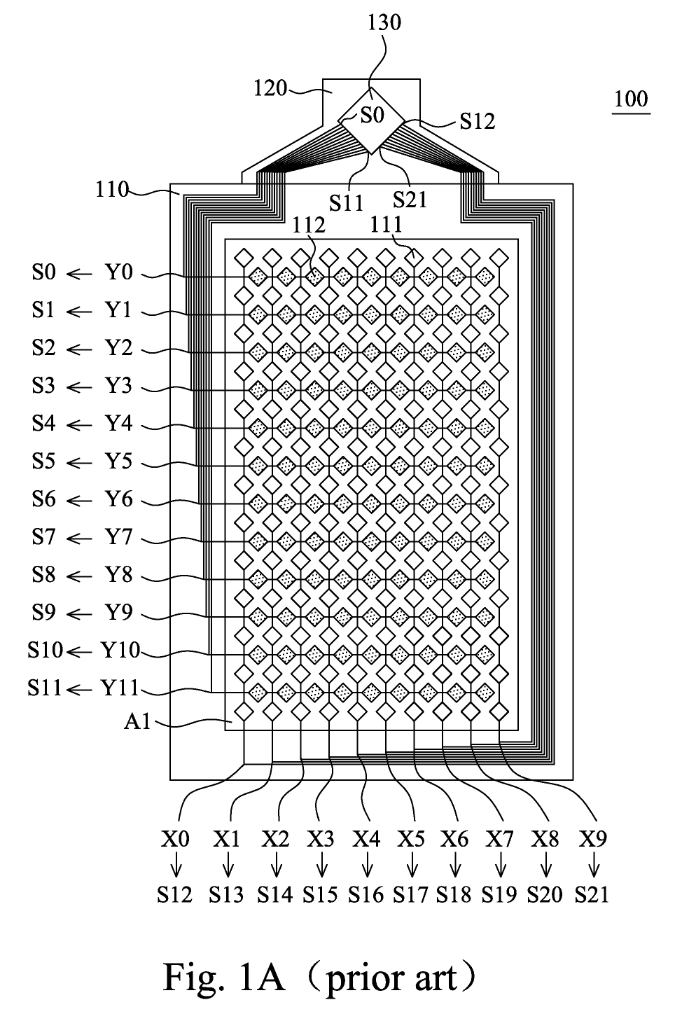

FIG. 1B is a schematic diagram of a structure of a conventional capacitive touch panel apparatus.

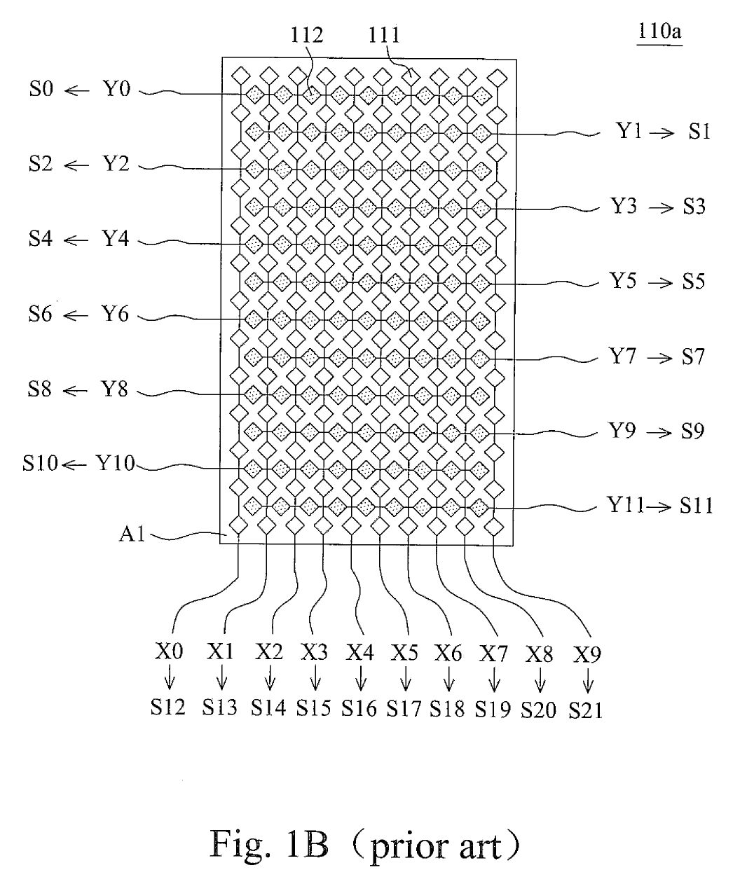

FIG. 1C is a schematic diagram of a structure of a conventional capacitive touch panel apparatus.

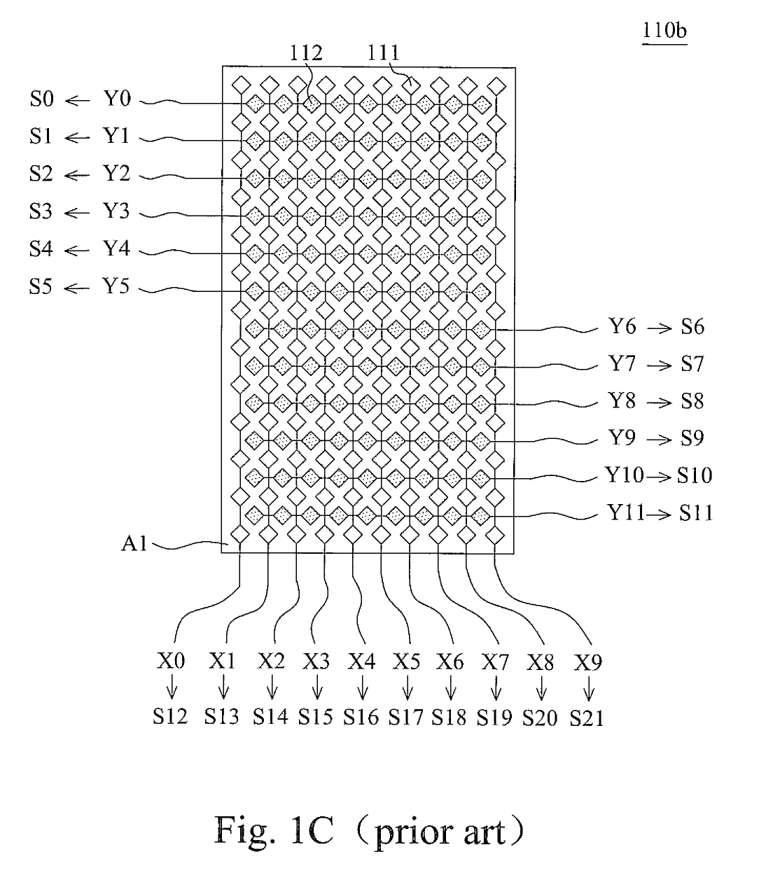

FIG. 2 is a block diagram of a touch control apparatus in accordance with an embodiment of the present disclosure.

FIG. 3 is a schematic diagram of a structure of a touch panel in accordance with an embodiment of the present disclosure.

FIG. 4 is a block diagram of a touch control apparatus in accordance with an embodiment of the present disclosure.

FIG. 5 is a block diagram of a touch control apparatus in accordance with an embodiment of the present disclosure.

FIG. 6 is a schematic diagram of a structure of a touch panel in accordance with an embodiment of the present disclosure.

FIG. 7 is a schematic diagram of an interface circuit in accordance with an embodiment of the present disclosure.

FIG. 8 is a flow chart of a method for controlling a touch panel in accordance with an embodiment of the present disclosure.

### DETAILED DESCRIPTION OF THE PREFERRED EMBODIMENT

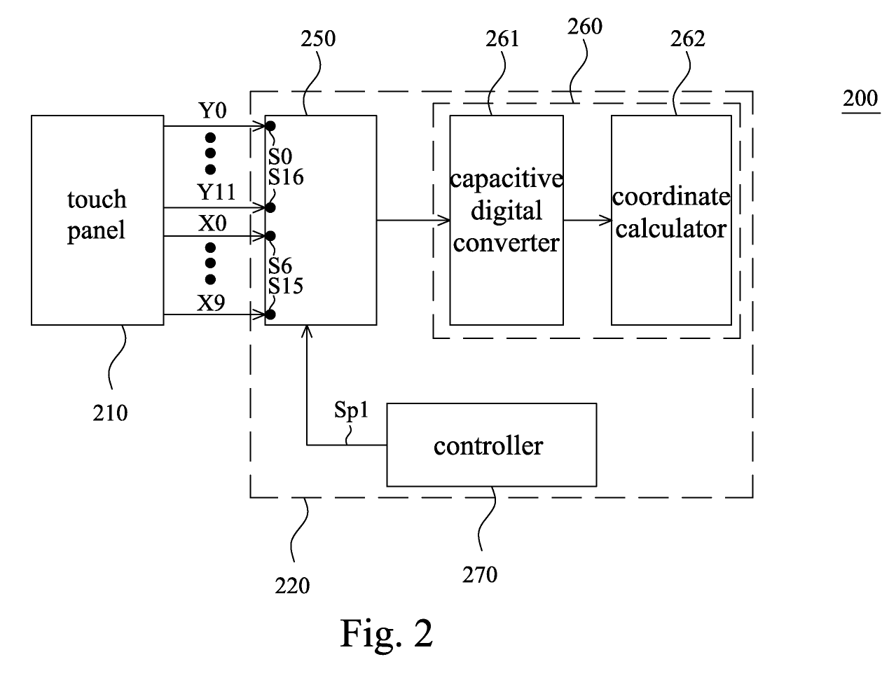

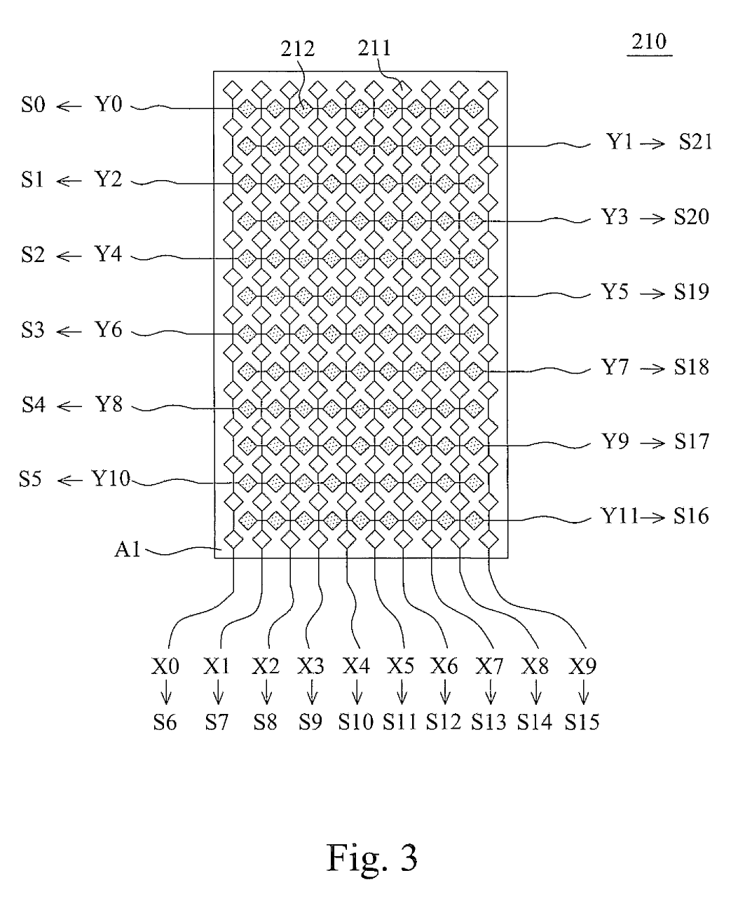

FIG. 2 is a block diagram of a touch control apparatus in accordance with an embodiment of the present disclosure. FIG. 3 is a schematic diagram of a structure of a touch panel in accordance with an embodiment of the present disclosure. Following description is given with reference to FIG. 2 and FIG. 3. A touch control apparatus 200 comprises a touch panel 210 comprising a plurality of sensing lines, and a sensing control apparatus 220 coupled to the touch panel 210. The sensing control apparatus 220, comprising a plurality of pins S0 to S15 that are respectively coupled to the sensing lines, adaptively controls a sequence for scanning the pins S0 to S15 according to connection relationships between the pins S0 to S15 and the sensing lines. Therefore, the pins S0 to S15 need not be coupled in a predetermined sequence to the sensing lines of the touch panel 210, but can be randomly coupled to the sensing lines. Accordingly, a circuit between the touch panel 210 and the sensing controller 220 is formed by a simplest approach to achieve an object of simplifying a circuit layout of the touch panel 210. Embodiments of the present disclosures are described below in detail.

FIG. 3 shows each of the sensing line detects whether the touch panel 220 is touched by an object to output a sensing result signal. In this embodiment, some of the sensing lines are roughly parallel to an X axis direction to sense positions in the X axis direction of the touch panel 210, and the rest are roughly parallel to an Y axis direction to sense positions in the Y axis direction of the touch panel 210. In FIG. 3, twelve sensing lines parallel to the X axis direction are illustrated, and ten sensing lines parallel to the Y axis direction are illustrated, for example. Each of the sensing lines parallel to the X axis direction comprises a plurality of capacitors 212 and a conductive wire. Conductive wires Y0 to Y11 are respectively coupled to nine capacitors 212. Each of the sensing lines parallel to the Y axis direction comprises a plurality of capacitors 211 and a conductive wire. Conductive wires X0 to X9 are respectively coupled to thirteen capacitors 211. In this embodiment, the conductive wires Y0, Y1, Y2, Y3, Y4, Y5, Y6, Y7, Y8, Y9, Y10, Y11, X0, X1, X2, X3, X4, X5, X6, X7, X8 and X9 are respectively coupled to pins S0, S21, S1, S20, S2, S19, S3, S18, S4, S17, S5, S16, S6, S7, S8, S9, S10, S11, S12, S13, S14 and S15 of the sensing control apparatus 220.

The sensing control apparatus 220 comprises the pins S0 to S21. In order to easily sense a coordinate data of a touched position on the touch panel 210, the sensing control apparatus 220 controls a sequence for scanning the pins S0 to S21 according to connection relationships between the pins S0 to S21 and the conductive wires Y0 to Y11 and X0 to X9. In this embodiment, the sequence for scanning the pins S0 to S21 is defined as {S0, S21, 51, S20, S2, S19, S3, S18, S4, S17, S5, S16, S6, S7, S8, S9, S10, S11, S12, S13, S14 and S15}, and the sensing control apparatus 220 scans the conductive wires Y0 to Y11 and X0 to X9 according to the sequence. Accordingly, the sensing control apparatus 220 controls a sequence for receiving the sensing result signals via the pins S0 to S21, and generates the coordinate data of the touched position on the touch panel 210 according to the sensing result signals. In this embodiment, the sensing control apparatus 220 programmably controls the sequence for scanning the pins S0 to S21 according to the connection relationships between the pins S0 to S21 and the conductive lines Y0 to Y11 and X0 to X9. Therefore, the pins S0 to S21 of the sensing control apparatus 220 need not be coupled in a predetermined sequence to the sensing lines. When the sensing control apparatus 220 is applied to a different touch panel 210, a circuit between the touch panel 210 and the sensing control apparatus 220 may be formed by a simplest approach. The sensing control apparatus 220 correspondingly controls the sequence for scanning the pins S0 to S21 according to the connection relationships between the pins S0 to S21 and the sensing lines, so as to significantly reduce complications of the circuit layout between the pins of the sensing control apparatus 220 and the sensing lines of the touch panel 210.

More specifically, the sensing control apparatus 220 comprises an interface circuit 250, a coordinate generating apparatus 260, and a controller 270. The interface circuit 250 comprises pins S0 to S21. The coordinate generating apparatus 260 receives the sensing result signals via the pins S0 to S21 of the interface circuit 250, and generates a coordinate data according to the sensing result signals. The controller 270 transmits a control signal Sp1 to the interface circuit 250. The interface circuit 250 selectively connects at least one of the pins S0 to S21 to the coordinate generating apparatus 260 with the sequence according to the control signal Sp1, so that the coordinate generating apparatus 260 receives the sensing result signals according to the sequence. More specifically, with the interface circuit 250, the controller 270 implements the control signal Sp1 to control the sequence for scanning the pins S0 to S21 according to the connection relationships between the pins S0 to S21 and conductive wires Y0 to Y11 and X0 to X9, so that the pins S0 to S21 are coupled in sequence to the coordinate generating apparatus 260.

In this embodiment, since a capacitor serves as a sensor, a sensing result signal represents a capacitance value. The coordinate generating apparatus 260 comprises a capacitive digital converter 261 and a coordinate calculator 262. The capacitive digital converter 261 generates a digital capacitance value corresponding to a capacitance value of each of the sensing result signals. The coordinate calculator 262 receives the digital capacitance values, and generates a coordinate data according to the digital capacitance values.

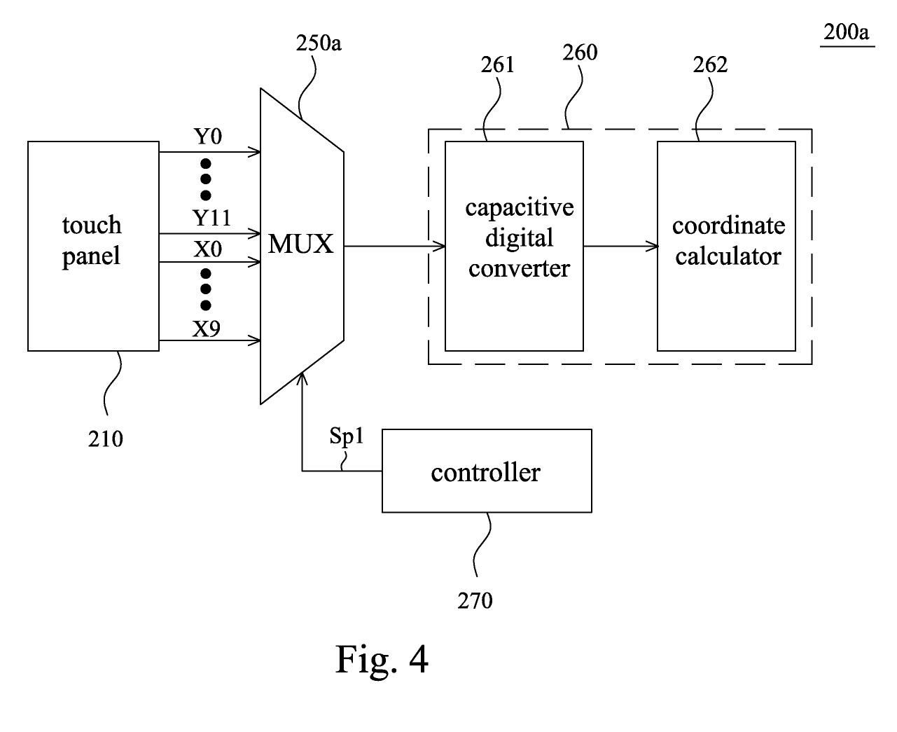

In an embodiment, the interface circuit 250 is a multiplexer. FIG. 4 is a block diagram of a touch control apparatus in accordance with an embodiment of the present disclosure. A touch control apparatus 200a in FIG. 4 is similar to the touch control apparatus 200 in FIG. 2. For illustration purposes, similar components in FIG. 4 are represented by symbols identical to those of the components in FIG. 2, and details thereof shall not be described for brevity. Referring to FIG. 4, an input end of a multiplexer 250a, composed of pins S0 to S21, is coupled to conductive wires Y0 to Y1 and X0 to X9. The controller 250 controls a sequence for scanning the pins S0 to S21 by the multiplexer 250a via a control signal Sp1 to output in sequence sensing result signals from the conductive wires Y0 to Y11 and X0 to X9 to the coordinate generating apparatus 260.

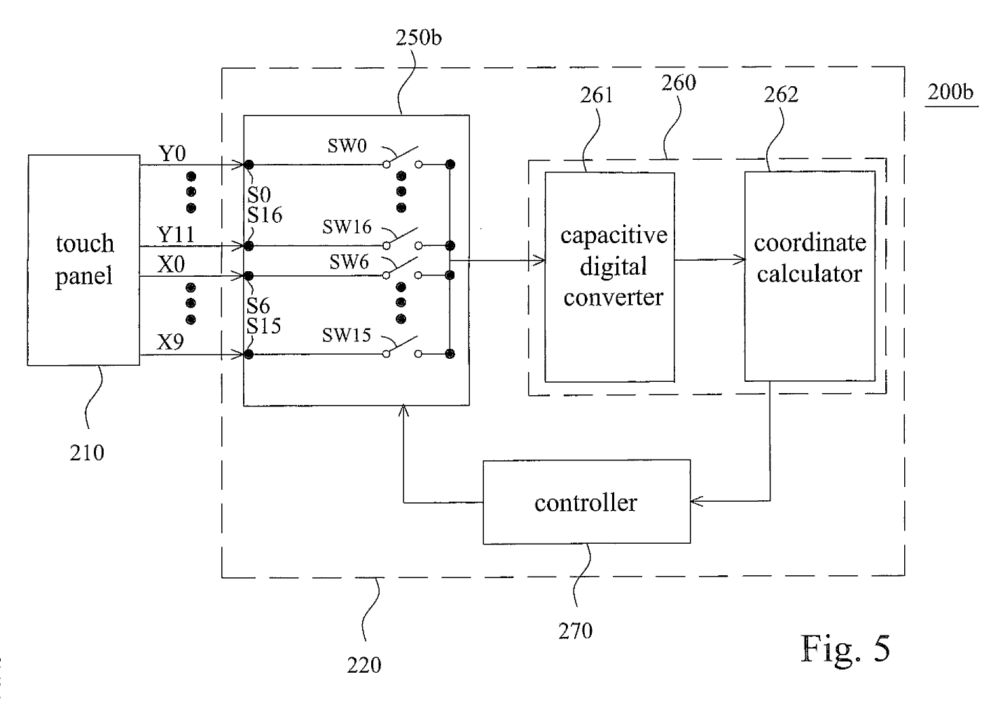

FIG. 5 shows a block diagram of a touch control apparatus in accordance with an embodiment of the present disclosure. A touch control apparatus 200b in FIG. 5 is similar to the touch control apparatus 200 in FIG. 2. For illustration purposes, similar components in FIG. 5 are represented by symbols identical to those of the components in FIG. 2, and details thereof shall not be described for brevity. FIG. 5 shows an interface circuit 250b comprises a plurality of switch components, each of which has a first end coupled to one of pins S0 to S21 and a second end coupled to the coordinate generating apparatus 260. Switch components SW0, SW16, SW6 and SW15 have first ends respectively coupled to the pins S0, S16, S6 and S15. Take the switch component SW0 as an example. The switch component SW0 switches between a first status and a second status. When the switch component SW0 is in the first status, the pin S0 is coupled to the coordinate generating apparatus 260, which receives a sensing result signal from a conductive wire (e.g., a conductive wire Y0) connected to the pin S0 via the pin S0; when the switch component SW0 is in the second status, the pin S0 is not coupled to the coordinate generating apparatus 260. According to the design of the interface circuit 250b, the controller 270 implements a control signal Sp1 to respectively control the switch components of the interface circuit 250b to enter the first status, so as to control a sequence for scanning the pins S0 to S21.

In an embodiment, the touch control apparatus 200b is operative in various modes, and the controller 270 controls the interface circuit 250b via different approaches under the various modes. Control mechanisms of the controller 270 in different modes shall be described below.

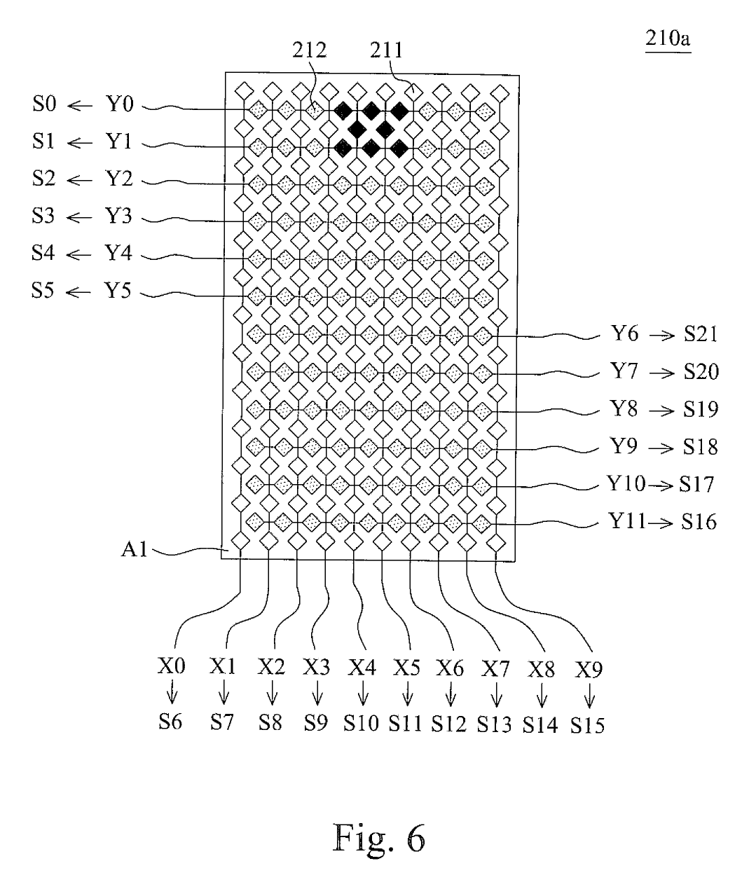

FIG. 6 shows a structure of a touch panel in accordance with an embodiment of the present disclosure. To simplify circuits of a sensing control apparatus 220 (not shown) provided on a PCB (not shown), for example, conductive wires Y0 to Y11 and X0 to X9 are respectively coupled to the pins S0, S1, S2, S3, S4, S5, S21, S20, S19, S18, S17, S16, S6, S7, S8, S9, S10, S11, S12, S13, S14 and S15 of the sensing control apparatus 220.

In this embodiment, the touch control apparatus 200b can be operative in an operating mode and a standby mode. In the operating mode, a coordinate data needs to be accurately sensed. Therefore, the controller 270 of the sensing control apparatus 220 scans each of the pins S0 to S21 of the interface circuit 250 according to a sequence {S0, S1, S2, S3, S4, S5, S21, S20, S19, S18, S17, S16, S6, S7, S8, S9, S10, S11, S12, 513, 514 and S15}.

In the standby mode or other predetermined mode, detection is focused mainly on an event of a touch rather than a precise coordinate data of the touch, i.e., the coordinate data may only comprise information of an X axis coordinate, or information that a certain position of the touch panel 210 is touched. For example, in the standby mode, only pins connected to the conductive wires X0 to X9 are scanned, and the touch control apparatus 200b only enters the operating mode when a touch is sensed on the touch control apparatus 200b. In an embodiment, in order to avoid misjudgments, a sensing area is narrowed down, e.g., only some of the conductive wires X0 to X9 and some of the conductive wires Y0 to Y11 are scanned. For example, the sensing area is narrowed down to an area comprising solid rhombuses in FIG. 6, and thus the controller 270 of the sensing control apparatus 220 controls the interface circuit 250 to only scan pins S0, S1, S10 and S11, i.e., only the conductive wires X4, X5, Y0 and Y1 are scanned. In addition, in an embodiment, in the standby mode or other predetermined modes, the controller 270 controls the interface circuit 250 to simultaneously scan the pins S0, S1, S10 and S11, so as to determine whether the area corresponding to the pins is touched. In the standby mode, power consumption is reduced by only scanning at least some of the pins S0 to S21 or scanning the pins S0 to S21 at a longer time interval.

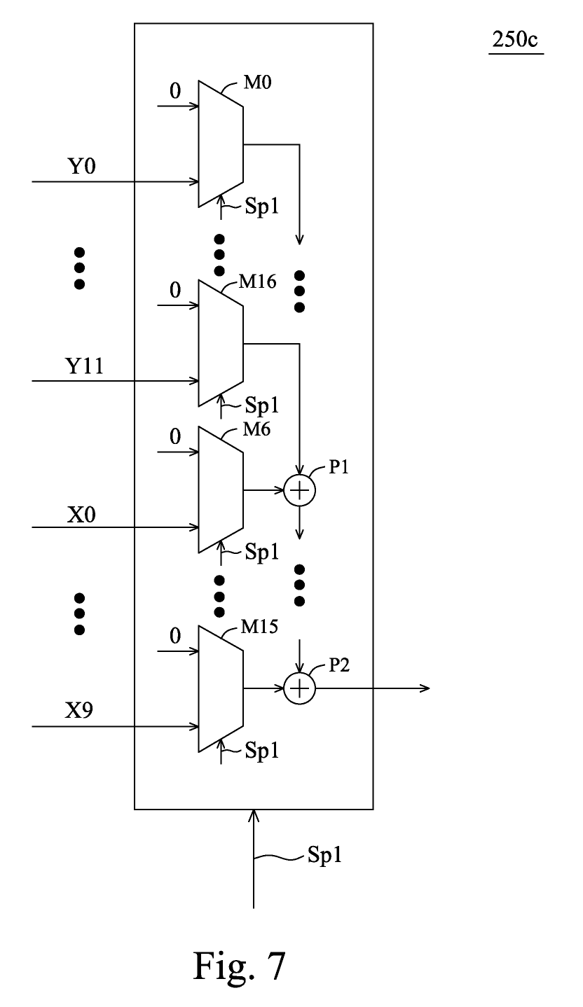

FIG. 7 shows a schematic diagram of an interface circuit in accordance with another embodiment of the present disclosure. An interface circuit 250c comprises a plurality of switch components. In an embodiment, the interface circuit 250c further comprises a plurality of adders. Each of the switch components of the interface circuit 250c may be a multiplexer. For example, switch components M0, M16, M6 and M15 respectively have first input ends coupled to pins S0, S16, S6 and S15, second input ends for respectively inputting a predetermined signal (e.g., zero), and output ends coupled to a coordinate generating apparatus 260 via at least one adder. For example, two adders P1 and P2 are illustrated in FIG. 7. Take the multiplexer M15 as an example. In the first status, the multiplexer M15 outputs a sensing result signal of a conductive wire X9 transmitted from the pin S15 coupled to its first input end; and in the second status, the multiplexer M15 outputs a predetermined signal. Sensing result signals or predetermined signals outputted from the adders, e.g., the adders P1 and P2, are added up to generate an added capacitance value to be outputted to the coordinate generating apparatus 260. In the operating mode, the controller 270 determines a sequence for scanning the pins S0 to S21 according to connection relationships between the pins S0 to S21 and the conductive wires Y0 to Y11 and X0 to X9, i.e., a sequence for switching the switch components by the interface circuit 250 to enter the first status is first determined, so that the coordinate generating apparatus 260 is allowed to receive according to the determined sequence the sensing result signals from the conductive wires Y0 to Y11 and X0 to X9. In the standby mode or other predetermined modes, the controller 270 controls the interface circuit 250c to scan only at least some of the pins, or controls switch components corresponding to at least some of the pins to enter the first status (i.e., at least some of the pins are simultaneously scanned), so as to reduce power consumption or immediately confirm whether a touch panel 210 is touched.

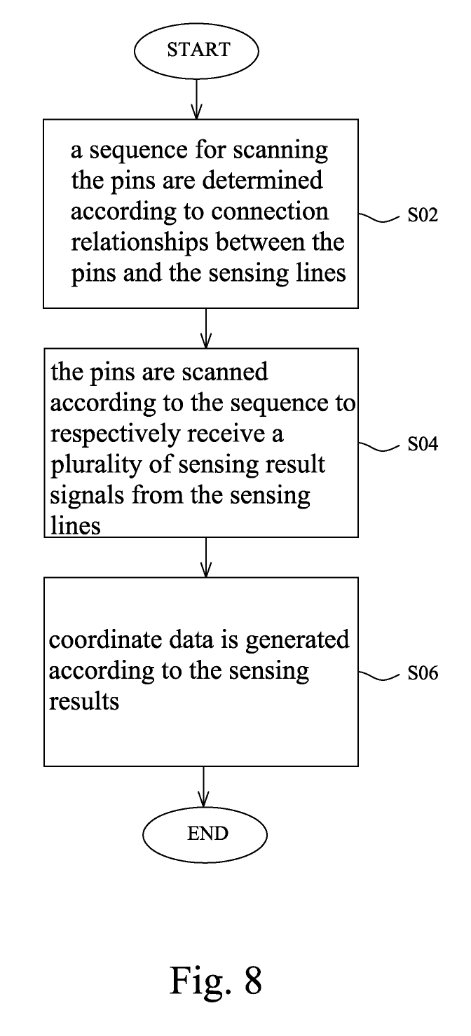

FIG. 8 shows a flow chart of a method for controlling a touch panel in accordance with an embodiment of the present disclosure. According to an embodiment of the present disclosure, a method for controlling a touch panel is applied to a sensing control apparatus comprising a plurality of pins, which are respectively connected to a plurality of sensing lines of a touch panel. The method for controlling a touch panel comprises steps below.

In Step S02, a sequence for scanning the pins are determined according to connection relationships between the pins and the sensing lines. In Step S04, the pins are scanned according to the sequence to respectively receive a plurality of sensing result signals from the sensing lines. In Step S06, a coordinate data is generated according to the sensing results.

In an embodiment, in a normal mode (e.g., the foregoing operating mode), the scanning sequence is a first sequence; and in a first predetermined mode (e.g., the foregoing standby mode), the scanning sequence is a second sequence for controlling to scan only at least some of the pins. In another embodiment, in a normal mode, the scanning sequence is a first sequence; and in a second predetermined mode (e.g., the foregoing standby mode), the scanning sequence is a third sequence for controlling to simultaneously scan at least some of the pins.

In conclusion, according to a touch control apparatus, an associated sensing control apparatus, and a method for controlling a touch panel provided by the present disclosure, since the sensing control apparatus is capable of controlling a sequence for scanning pins according to connection relationships between the pins and the sensing lines, circuits between the touch panel and the sensing control apparatus may be formed by a simplest approach, so as to significantly reduce complications involved in a circuit layout between the sensing control apparatus and the touch panel. In addition, the sensing control apparatus and an associated method are capable of only scanning a partial area of the touch panel or scanning the touch panel at a longer time interval to reduce power consumption.

While the disclosure has been described in terms of what is presently considered to be the most practical and preferred embodiments, it is to be understood that the present disclosure needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A touch control apparatus, comprising:
a touch panel, comprising a plurality of sensing lines; and
a sensing control apparatus, comprising a plurality of pins respectively coupled to the sensing lines,
wherein, the sensing control apparatus adaptively controls a sequence for scanning the pins according to connection relationships between the pins and the sensing lines.

2. The touch control apparatus as claimed in claim 1, wherein each of the sensing lines comprises a sensor and a conductive wire for connecting to the sensor.

3. The touch control apparatus as claimed in claim 2, wherein the sensors comprise capacitors.

4. The touch control apparatus as claimed in claim 1, wherein the sensing control apparatus comprises:
an interface circuit that comprises the pins; and
a controller that controls the interface circuit to scan the pins in accordance with the sequence.

5. The touch control apparatus as claimed in claim 4, wherein the sensing control apparatus further comprises:
a coordinate generating apparatus that receives a plurality of sensing results generated by the sensing lines via the pins of the interface circuit, and generates coordinate data according to the sensing results.

6. The touch control apparatus as claimed in claim 5, wherein the interface circuit comprises a multiplexer, coupled between the pins and the coordinate generating apparatus, that selectively outputs the sensing results received from the pins according to control of the controller.

7. The touch control apparatus as claimed in claim 5, wherein the interface circuit comprises a plurality of switch components, respectively coupled to between the pins and the coordinate generating apparatus, that selectively and respectively switch between a first status and a second status according to control of the controller.

8. The touch control apparatus as claimed in claim 7, wherein in a first predetermined mode, the controller controls the interface circuit to simultaneously scan at least some of the pins.

9. The touch control apparatus as claimed in claim 8, wherein in the first predetermined mode, the controller controls those switch components corresponding to the scanned pins to enter the first status, and controls remaining switch components corresponding to the unscanned pins to enter the second status.

10. The touch control apparatus as claimed in claim 4, wherein in a second predetermined mode, the controller controls the interface circuit to scan in sequence at least some of the pins.

11. A sensing control apparatus, applied to a touch panel comprising a plurality of sensing lines, comprising:
an interface circuit, comprising a plurality of pins respectively connected to the sensing lines; and
a controller, that adaptively controls a sequence in accordance with which the interface circuit scans the pins according to connection relationships between the pins and the sensing lines.

12. The sensing control apparatus as claimed in claim 11, further comprising:
a coordinate generating apparatus, that receives a plurality of sensing results generated by the sensing lines via the pins of the interface circuits, and generates coordinate data according to the sensing results.

13. The sensing control apparatus as claimed in claim 12, wherein the interface circuit comprises a multiplexer, coupled between the pins and the coordinate generating apparatus, that selectively outputs the sensing results received from the pins to the coordinate generating apparatus according to control of the controller.

14. The sensing control apparatus as claimed in claim 12, wherein the interface circuit comprises a plurality of switch components, respectively coupled between the pins and the coordinate generating apparatus, that selectively and respectively switch between a first status and a second status according to control of the controller.

15. The sensing control apparatus as claimed in claim 14, wherein in a first predetermined mode, the controller controls the interface circuit to simultaneously scan at least some of the pins.

16. The sensing control apparatus as claimed in claim 11, wherein in a second predetermined mode, the controller controls the interface circuit to scan in sequence at least some of the pins.

17. A method for controlling a touch panel, applied to a sensing control apparatus comprising a plurality of pins respectively coupled to a plurality of sensing lines of the touch panel, the method comprising:
determining a sequence for scanning the pins according to connection relationships between the pins and the sensing lines;
scanning the pins according to the sequence to respectively receive a plurality of sensing results from the sensing lines; and
generating coordinate data according to the sensing results.

18. The method as claimed in claim 17, wherein in a first predetermined mode, at least some of the pins are scanned according to the sequence.

19. The method as claimed in claim 17, wherein in a second predetermined mode, at least some of the pins are simultaneously scanned according to the sequence.
